(19) United States
(12) Patent Application Publication
(10) Pub. No.: US 2020/0282787 A1
(43) Pub. Date: Sep. 10, 2020

(54) TOP SUSPENSION MOUNT COMPRISING A REMOVABLE INSERT, ASSEMBLY COMPRISING SUCH A MOUNT, AND MANUFACTURING PROCESS FOR SUCH A MOUNT

(71) Applicant: Vibracoustic Nantes SAS, Rue du Terte -BP 10419 (FR)

(72) Inventors: Jérôme Kieffer, Nantes (FR); Gerard Poindessault, Nantes (FR)

(73) Assignees: Vibracoustic Nantes SAS, Carquefou (FR); Vibracoustic Nantes SAS, Carquefou (FR)

(21) Appl. No.: 16/322,523

(22) PCT Filed: Jul. 21, 2017
(86) PCT No.: PCT/EP2017/068469

§ 371 Date: Feb. 1, 2019

(30) Foreign Application Priority Data
Aug. 3, 2016 (FR) 1657533

(51) Int. Cl. B60G 13/00

(52) U.S. Cl. CPC B60G 13/003; B60G 2204/128; B60G 2206/7104; B60G 2204/41; B60G 2206/8101; B60G 2206/8209; B60G 2206/91; B60G 2206/73

(57) ABSTRACT

Vehicle top suspension mount comprising an anti-vibratory block housed in a casing and a removable insert. The anti-vibratory block may comprise an elastomeric body having a first contact surface and the removable insert may have a second contact surface. The second contact surface may be distant from the first contact surface. The elastomeric body may be deformable so that the first contact surface cooperates at least partially as a support with the second contact surface.

### CROSS-REFERENCE TO RELATED APPLICATION

This application is a National Stage Patent Application of International Patent Application No. PCT/EP2017/068469, filed Jul. 21, 2017, which claims the benefit of French Application Serial No. 1657533, filed Aug. 3, 2016, the contents of each are incorporated by reference in their entireties.

### TECHNICAL FIELD

The invention relates to the field of anti-vibratory devices for vehicles, and more particularly a top suspension mount, an assembly comprising such a mount and a shock absorber, as well as a process for manufacturing such a top suspension mount.

### BACKGROUND

The known vehicle top suspension mounts generally comprise three distinct elements, an anti-vibratory block, a metal casing receiving the anti-vibratory block and a cover fastened to the casing so as to limit the deflection of at least a part of the anti-vibratory block. In other words, the cover cooperates, as a stop, with the anti-vibratory block in a predetermined direction. The anti-vibratory block is first assembled to the casing, while the cover is fixed to the casing in a second step, generally by crimping or punching. Such assembly is long and costly. There is therefore a need in this direction.

### SUMMARY

The present disclosure relates to a vehicle top suspension mount.

One embodiment relates to a vehicle top suspension mount comprising an anti-vibratory block housed in a casing, and a removable insert, the anti-vibratory block comprising an elastomeric body having a first contact surface while the removable insert has a second contact surface, the second contact surface being distant from the first contact surface, in which the elastomeric body is deformable so that the first contact surface cooperates at least partially, as a support, with the second contact surface.

It is understood that the removable insert is a distinct part of the anti-vibratory block and of the casing, and which is inserted in the assembly formed by the anti-vibratory block and the casing while being able to be withdrawn from it. For example, the insert is force-fitted.

It is likewise understood that when the insert is assembled with the assembly formed by the casing and the anti-vibratory block, a space is arranged between the first contact surface and the second contact surface so that under at least one regime of the deformation of the elastomeric body, the first contact surface and the second contact surface cooperates wholly or partially with each other. In other words, the elastomeric body has at least one deformation where the first contact surface cooperates wholly or partially with the second contact surface. Of course, no element extends into the space between the first contact surface and the second contact surface.

It is likewise understood that the first contact surface is formed integrally by a single wall (i.e. so the first surface is continuous) or has several parts formed by distinct walls (i.e. so the first surface is discontinuous). Likewise, the second contact surface is formed integrally by a single wall (i.e. so the second surface is continuous) or has several parts formed by distinct walls (i.e. so the second surface is discontinuous). For example, the first contact surface has as many parts as the second contact surface, but not necessarily.

Such a top suspension mount structure is simple while its assembly is particularly easy thanks to the insert. It is sufficient to merely insert the insert into the assembly formed by the casing and the anti-vibratory block to complete the assembly of the vehicle top suspension mount. Thus, the irksome step of crimping or punching the cover of the top suspension mount known is avoided.

Moreover, the deflection of the anti-vibratory block during the deformations of the elastomeric body remains controlled by the cooperation of the first contact surface with the second contact surface. Indeed, during the at least one regime of deformation of the elastomeric body, the first contact surface makes contact with the second contact surface, as a result of which the deformation of the elastomeric body is limited which limits the stroke of the anti-vibratory block. This makes it possible to obtain a damping behaviour with two regimes of the top suspension mount, namely a first regime where the elastomeric body is free to deform and hence shows a certain rigidity, and a second regime where the elastomeric body cooperates with the second contact surface so that the rigidity of the top suspension mount is higher in relation to its rigidity in the first regime.

In certain embodiments, the first contact surface is arranged opposite the second contact surface.

For example, the space between the first and second surfaces is substantially constant, but not necessarily. Such a configuration is simple to implement, and makes it possible to obtain a structure simple to assemble.

In certain embodiments, the anti-vibratory block comprises a ring configured to be joined to a shock absorber rod, said ring extending in an axial direction, the removable insert comprising fingers extending in an axial direction, the second contact surface extending onto the fingers.

It is thus understood that the second contact surface is discontinuous and extends onto all the fingers (i.e. onto at least one wall of each of the fingers). Of course, the shape of the fingers is not limited. It is likewise understood that the second contact surface extends in the axial direction. For example, the first contact surface likewise extends in the axial direction, but not necessarily.

The anti-vibratory block comprises the elastomeric body and the ring. Thus, it is understood that when a shock absorber is fastened to the ring, the ring is subjected to different forces during the use of the vehicle. Those forces move the ring and deform the elastomeric body, especially in a direction perpendicular to the axial direction (i.e. in a radial direction). The second contact surface hence contacts the first contact surface when the elastomeric body deforms radially.

Such a structure is simple and permits easy joining of the insert to the assembly formed by the anti-vibratory block and the casing.

In certain embodiments, the insert is configured to be inserted in the axial direction into the assembly formed by the casing and the anti-vibratory block.

Such a configuration permits particularly easy and reliable assembly, the forces to which the second contact surface is subjected being perpendicular to the axial direction. Thus, the deformations of the elastomeric body do not run the risk of withdrawing the insert from the assembly formed by the anti-vibratory block and the casing.

In certain embodiments, the anti-vibratory block comprises a ring configured to be joined to a shock absorber rod, said ring extending in an axial direction, the elastomeric body being deformable so that the first contact surface cooperates at least partially as a support with the second contact surface when the ring is moved in an axial direction.

It is therefore understood that when the ring is moved axially, that is to say, when an axial force is applied to the ring by a shock absorber, the elastomeric body deforms so that the first contact surface cooperates as a support with the second contact surface. For example, when the first and second contact surfaces extend axially, the elastomeric body is deformed in the radial direction when the ring is moved in the axial direction so that the first contact surface wholly or partially becomes a support against the second contact surface.

The present disclosure likewise relates to an assembly comprising a vehicle top suspension mount and a shock absorber.

One embodiment relates to an assembly comprising a vehicle top suspension mount, such as described in the present disclosure, joined to a shock absorber.

The present disclosure relates also to a manufacturing process of a vehicle top suspension mount.

One embodiment relates to a manufacturing process for a vehicle top suspension mount such as described in the present disclosure, comprising the steps of supplying an anti-vibratory block comprising an elastomeric body having a first contact surface, over-moulding a casing around the anti-vibratory block by providing at least one space opposite the first contact surface, furnishing a removable insert having a second contact surface, the removable insert being able to be joined to the element formed by the casing and the anti-vibratory block so that the first contact surface is distant from the second contact surface and can cooperate at least partially with the second contact surface during at least one deformation of the elastomeric body.

The structure of the vehicle top suspension mount, the subject matter of the present disclosure, makes it possible to manufacture the assembly formed by the anti-vibratory block and the casing in a single piece. This is particularly advantageous and reduces the number of steps necessary for the assembly of said top suspension mount. The assembly of the upper suspension support thus does not comprise more than the step of the insertion of the removable insert into the assembly comprising the casing and the anti-vibratory block.

Thus, it is possible to manufacture the casing of polymeric material and to over-mould it on the anti-vibratory block, and especially on the elastomeric body. A polymeric material is a mixture containing a base material (generally a polymer) which may be moulded, shaped, generally hot and/or under pressure, in order to produce one piece. For example, the polymeric material is a synthetic organic polymeric material. For example, the polymeric material is a thermoplastic.

In certain embodiments, the removable insert can be assembled so that the second contact surface is arranged opposite the first contact surface.

In certain embodiments, the elastomeric body is over-moulded around the ring.

Thus, the elastomeric body is over-moulded around the ring while the casing is over-moulded around the elastomeric body. Such a process is particularly well suited to manufacturing such a vehicle top suspension mount on an industrial scale and in an optimum manner.

### BRIEF DESCRIPTION OF THE DRAWINGS

The invention and its advantages will be better understood after the reading of the detailed description provided below of different embodiments of the invention given as non-limiting examples. This description refers to the pages of annexed figures, on which:

FIG. 1 shows a perspective view of a vehicle top suspension mount, the removable insert approaching the assembly comprising the casing and the anti-vibratory block,

FIG. 2 shows the vehicle top suspension mount seen according to sectional drawing II of FIG. 1,

FIGS. 3A to 3C show three phases in the course of assembly of the vehicle top mount fitted to a shock absorber, with a vehicle body, and

FIG. 4 shows the deformations of the elastomeric body during the axial movement of the ring.

### DETAILED DESCRIPTION

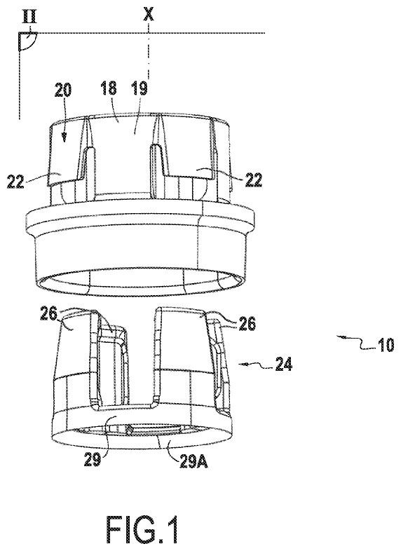

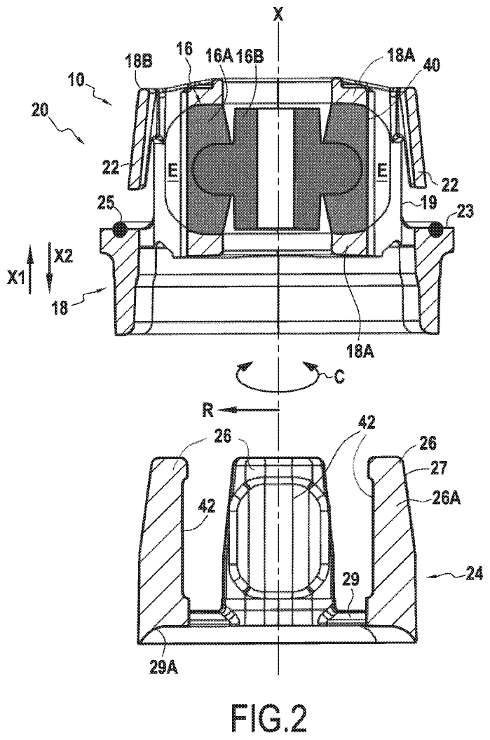

FIGS. 1 and 2 show a vehicle top suspension mount 10 seen in perspective and in section respectively, where removable insert 24 is not inserted into assembly 20 formed by casing 18 and anti-vibratory block 16

Anti-vibratory block 16 comprises elastomeric body 16A having a first contact surface 40 and a ring 16B configured to be joined to a shock absorber rod, this ring 16B showing a rotationally symmetrical shape extending along axis X. More generally, the anti-vibratory block 16 extends in the axial direction X. The first contact surface 40 likewise extends in the axial direction X. Of course, the elastomeric body 16A is more flexible than ring 16B so as to be able to deform elastically and to damp the vibrations sustained by ring 16B so that those vibrations are not transmitted, wholly or partially, to casing 18. For example, ring 16B is made of metal or of polymeric material. For the manufacturing of anti-vibratory block 16, the elastomeric body 16A is over-moulded around ring 16B.

Casing 18 is made of polymeric material and over-moulded around anti-vibratory block 16. Thus, assembly 20 formed by anti-vibratory block 16 and by casing 18 forms one single piece. A space E is provided opposite the first contact surface 40. Casing 18 has an annular shape of axis X. In particular, the casing shows internal portion 18A which encloses both sides of the anti-vibratory block in axial direction X. In other words, anti-vibratory block 16 is sandwiched in axial direction X by internal portion 18A of casing 18.

Of course, and this broadly speaking, a radial direction R is a direction perpendicular to axis X. The azimuthal or circumferential direction C corresponds to the direction describing a ring around axial direction X. The three directions—axial X, radial R and azimuthal C correspond to the directions defined by elevation, radius and angle respectively within a cylindrical coordinate system. Finally, unless otherwise stated, the adjectives “internal” and “external” are used with reference to a radial direction R so that the interior part (i.e. radially interior) of an element is closer to axis X than the external part (i.e. radially external) of the same element.

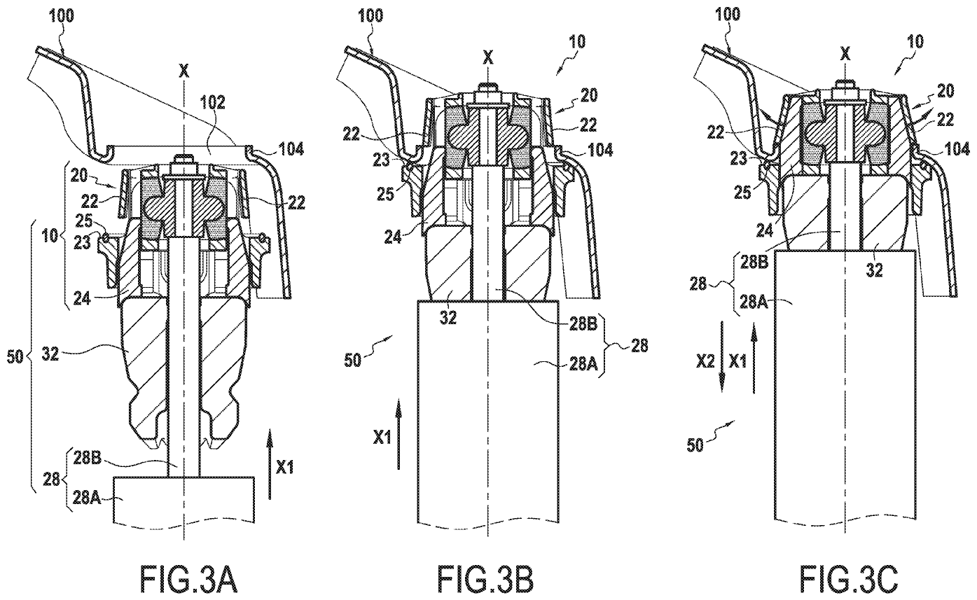

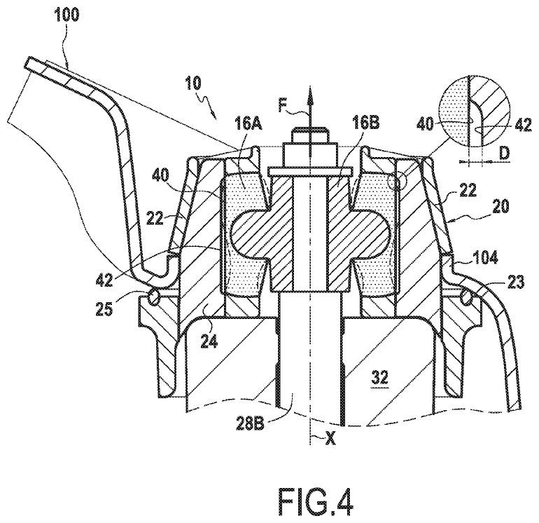

Casing 18 has an external portion 18B showing a peripheral wall 19, tongues 22 configured to cooperate with a vehicle body and each forming a securing element being arranged in the peripheral wall 19. In this embodiment, casing 18 comprises four tongues 22. Each tongue 22 extends substantially in axial direction X in assembly position (that is to say, forming an angle lower than 30° to the axial direction). Each tongue 22 is movable between an assembly position, a position shown in FIGS. 1, 2, 3A and 3B, and a securing position, a position shown in FIGS. 3C and 4. It is noted that in the assembly position the tongues 22 project radially towards the exterior of the peripheral wall 19 while in the securing position tongues 22 “project even more” towards the outside of the peripheral wall 19, that is to say, that they project radially towards the outside beyond the assembly position. Moreover, in this example, by their elasticity, the natural position of the tongues 22 (i.e. at rest or when they are not subject to any constraint) correspond to the assembly position. Tongues 22 are configured to block, in the securing position, top suspension mount 10 in relation to a vehicle body when vehicle top mount is joined to a vehicle body (see FIG. 3C).

Casing 18 likewise has a shoulder 23 configured to cooperate with a vehicle body. This shoulder 23 is annular and extends circumferentially along the whole periphery of the external portion 18B of casing 18. In this example, shoulder 23 comprises O-ring 25.

Thus, shoulder 23 is configured to cooperate as a support with a vehicle body in a first axial direction X1 while tongues 22 are configured to cooperate as a support with the vehicle body in a second axial direction X2 opposite to the first axial direction X1.

The removable insert 24 has an annular shape of axis X, and has as many fingers 26 as casing 18 has tongues 22, namely in this embodiment four fingers 26. Fingers 26 extend in axial direction X from an annular base 29. The insert is configured to be inserted in axial direction X into assembly 20 formed by anti-vibratory block 16 and casing 18. It is noted that surface 29A of base 29 opposite the fingers 26 forms a centring fillet configured to cooperate in a form-locking manner with a jounce bumper 32 (see FIG. 4).

The internal faces of the fingers 26 form a second contact surface 42 extending in axial direction X opposite to and at a distance from first contact surface 40. Thus, the first and second contact surfaces 40 and 42 are discontinuous. Of course, according to one variant, the first contact surface could be continuous while the second contact surface is discontinuous, or inversely. When insert 24 is inserted into assembly 20 formed by anti-vibratory block 16 and casing 18, first contact surface 40 and second contact surface 42 are radially distant from each other by a distance D (see FIG. 4).

The distal end portion 26A of fingers 26 has an inclined external surface 27 so that the distance between surface 27 and axis X decreases in axial direction X going towards the distal end of the fingers (i.e. in axial direction X1). This inclined surface 27 is configured to cooperate as a support with tongues 22 so as to bring, during the insertion of insert 24 into assembly 20, tongues 22 from the assembly position to the securing position, and to keep tongues 22 in the securing position. Thus, insert 24 is configured to bring tongues 22 from the assembly position towards the securing position and to lock tongues 22 into the securing position.

It is noted that insert 24 is inserted into assembly 20 so that fingers 26 extend into space E, extending axially and arranged radially between external portion 18B of casing 18, on the one hand, and the anti-vibratory block 16 of internal portion 18A of casing, on the other. Moreover, casing 18 and insert 24 are configured so that insert 24 is force-fitted into assembly 20. Space E opening being on both sides of assembly 20 in axial direction X, to withdraw insert 24 from assembly 20 it is for example possible to press the distal end of fingers 26 in direction X2.

We will now describe the joining of the top suspension mount 10 to a vehicle body with reference to FIGS. 3A à 3C. In this example, top suspension mount 10 is part of an assembly 50 comprising, furthermore, shock absorber 28 and jounce bumper 32. Top suspension mount 10 is fastened to shock absorber 28, and more particularly to rod 28B of shock absorber 28 in a manner known elsewhere. Moreover, jounce bumper 32 is fitted to rod 28B and arranged axially between body 28A of the shock absorber 28 and removable insert 24.

In FIG. 3A, insert 24 is only partly inserted into assembly 20 formed by anti-vibratory block 16 and casing 18, so that it does not cooperate with tongues 22. Tongues 22 are thus in the assembly position.

In FIG. 3A, assembly 50 is shown opposite vehicle body 100, and upper suspension support 10 is introduced into housing 102 of body 100 provided for this purpose. Considered in axial direction X (i.e. in the vertical direction in FIGS. 3A, 3B and 3C), assembly 20 formed by anti-vibratory block 16 and by casing 18 forms the upper part of top suspension mount 10 which is introduced first into housing 102, from the bottom. In other words, casing 18 is inserted into housing 102. Insert 24 forms the lower part of the upper suspension support 10.

Top suspension mount 10 is introduced into housing 102 in axial direction X1 until shoulder 23 cooperates as a support (directly and/or via O-ring 25) with body 100. Tongues 22 being in the assembly position, they do not hamper the introduction of top suspension mount 10 into housing 102 and do not cooperate with rim 104 of housing 102.

In FIG. 3B, shoulder 23 cooperates as a support with body 100 while tongues 22 are always in the assembly position. Shock absorber 28 continues to be pushed upwards in axial direction X1 so that rod 28B sinks into body 28A and body 28A presses jounce bumper 32. Thus, insert 24 is fitted into assembly 20 with shock absorber 28 by means of jounce bumper 32 in axial direction X in insertion direction X1.

In FIG. 3C, the insertion of insert 24 into assembly 20 has been completed so that insert 24 brought tongues 22 from the assembly position to the securing position, as symbolised by the thick-line arrows. Tongues 22 hence project more towards the outside of casing 18 than in assembly position so that their distal end cooperates with body 100, and more particularly in this embodiment with the shoulder formed by rim 104, and block top mount 10 in axial direction X in the direction of withdrawal from the top suspension mount 10 in relation to vehicle body 100 (i.e. in direction X2). Of course, when the pressure exerted on shock absorber 28 is released, shock absorber 28 and jounce bumper 32 return to the initial position while insert 24, force-fitted into assembly 20 remains in position inside assembly 20 and locks tongues 22 in the securing position.

FIG. 4 shows in more detail the top suspension mount 10 joined to vehicle body 100. In this configuration, tongues 22 are in the securing position while first contact surface 40 and second contact face 42 are opposite each other and distant from each other by a distance D. When an axial force F is applied by shock absorber 28 to ring 16B so that ring 16B moves in axial direction X, the elastomeric body 16A deforms so that first contact surface 40 cooperates at least partially as a support with second contact surface 42 in accordance with at least one regime of deformation of the elastomeric body 16A (i.e. according to at least one deformation of the elastomeric body 16A). Such a regime of deformation is shown as a dashed line in FIG. 4. Thus, it is considered that elastomeric body 16A is deformable so that first contact surface 40 cooperates at least partially as a support with second contact surface 42. Thanks to this cooperation as a support for the contact surfaces 40 and 42, the amplitude of the deflection of ring 16B in axial direction X is limited.

Although the present invention has been described with reference to specific embodiments, it is obvious that modifications and changes can be made to these examples without departing from the general scope of the invention such as defined by the claims. In particular, individual characteristics of the different embodiments illustrated/mentioned can be combined in additional embodiments. Consequently, the description and the drawings must be considered in an illustrative rather than restrictive sense.

It is likewise obvious that all the characteristics described with reference to a process are transposable, alone or in combination, to a device, and inversely, all the characteristics described with reference to a device are transposable, alone or in combination, to a process.

1. Vehicle top suspension mount, comprising:
an anti-vibratory block housed in a casing, and
a removable insert,
wherein the anti-vibratory block comprises an elastomeric body having a first contact surface; the removable insert has a second contact surface, the second contact surface being distant from the first contact surface; and the elastomeric body is deformable so that the first contact surface cooperates at least partially as a support with the second contact surface.

2. Vehicle top suspension mount according to claim 1, in which the first contact surface is arranged opposite the second contact surface.

3. Vehicle top suspension mount according to claim 1, wherein the anti-vibratory block comprises a ring configured to be joined to a shock absorber rod, said ring extending in an axial direction; the removable insert comprises fingers extending in the axial direction; and the second contact surface extends over the fingers.

4. Vehicle top suspension mount according to claim 3, in which the removable insert is configured to be inserted in the axial direction into an assembly formed by the casing and the anti-vibratory block.

5. Vehicle top suspension mount according to claim 3, wherein the anti-vibratory block comprises a ring configured to be joined to the shock absorber rod; said ring extends in an axial direction; and the elastomeric body is deformable so that the first contact surface cooperates at least partially as the support with the second contact surface when the ring is moved in the axial direction.

6. Assembly comprising the vehicle top suspension mount according to claim 1 joined to a shock absorber.

7. Manufacturing process for a vehicle top suspension mount, the process comprising the steps of:
supplying an anti-vibratory block comprising an elastomeric body having a first contact surface,
over-moulding a casing around the anti-vibratory block providing at least one space opposite first contact surface, and
furnishing a removable insert having a second contact surface, the removable insert being able to be joined to the element formed by the casing and the anti-vibratory block so that the first contact surface is distant from the second contact surface and so that the first contact surface can cooperate at least partially with the second contact surface during at least one deformation of the elastomeric body.

8. Process according to claim 7, in which the removable insert can be assembled so that the second contact surface is arranged opposite the first contact surface.

9. Process according to claim 7, in which the anti-vibratory block comprises a ring, and the elastomeric body is over-moulded around the ring.
